(19) United States
(12) Patent Application Publication
(10) Pub. No.: US 2008/0162257 A1
(43) Pub. Date: Jul. 3, 2008

(54) TRACKING RESPONSES TO ADVERTISEMENTS IN STATIC WEB PAGES

(75) Inventors: Ashutosh Garg, Sunnyvale, CA (US); Sridhar Venkatakrishnan, Bangalore (IN)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/618,311

(22) Filed: Dec. 29, 2006

(51) Int. Cl. G06Q 30/00

(52) U.S. Cl. 705/10; 705/14

(57) ABSTRACT

The present disclosure includes a system and method for tracking responses to advertisements in static images. In some implementations, a method for tracking advertisements includes transmitting a static image for displaying an advertisement in the static Web page in response to at least a request for an advertisement to embed in a static Web page. The advertisement is associated with an advertiser. The actions associated with the embedded ad image are tracked independent of the advertiser.

### TECHNICAL FIELD

This application relates to advertising.

### BACKGROUND

Content delivery over the Internet continues to improve every day. Computer users can receive e-mail, news, games, entertainment, music, books, and web pages—all with a simple Internet connection (and with improved quality on a broadband connection). Internet users also have access to a plethora of services such as maps, shopping links, images, blogs, local search, satellite images, group discussions, hosted content, and e-mail. While many of these services are free to users, such services are often accompanied by an advertisement (“ad”) that helps service providers defray the cost of providing these services. In addition, the advertisement may also add value to the user experience.

### SUMMARY

The present disclosure includes a system and method of tracking responses to advertisements in static images. In some implementations, a method for tracking advertisements includes transmitting a static image for displaying an advertisement in the static Web page in response to at least a request for an advertisement to embed in a static Web page. The advertisement is associated with an advertiser. The actions associated with the embedded ad image tracked independent of the advertiser.

The foregoing example methods may be embodied in software—as well as other disclosed methods—and as such may be of the form of computer implementable methods. Moreover, some or all of these aspects may be further included in respective systems for tracking advertisements embedded in static images, as well as in other enterprise or marketing systems of software. The details of these and other aspects and implementations of the disclosure are set forth in the accompanying drawings and the description below. Other features, objects, and advantages of the various implementations will be apparent from the description and drawings, as well as from the claims.

### DESCRIPTION OF DRAWINGS

FIG. 1 is a block diagram illustrating an exemplary advertising system in accordance with some implementations of the present disclosure;

FIG. 2 is an example Web page illustrating HTML code for tracking actions associated with advertisements in the advertising system of FIG. 1; and

FIG. 3 is a flow diagram illustrating an example method for tracking actions associated with advertisements in the advertising system of FIG. 1.

### DETAILED DESCRIPTION

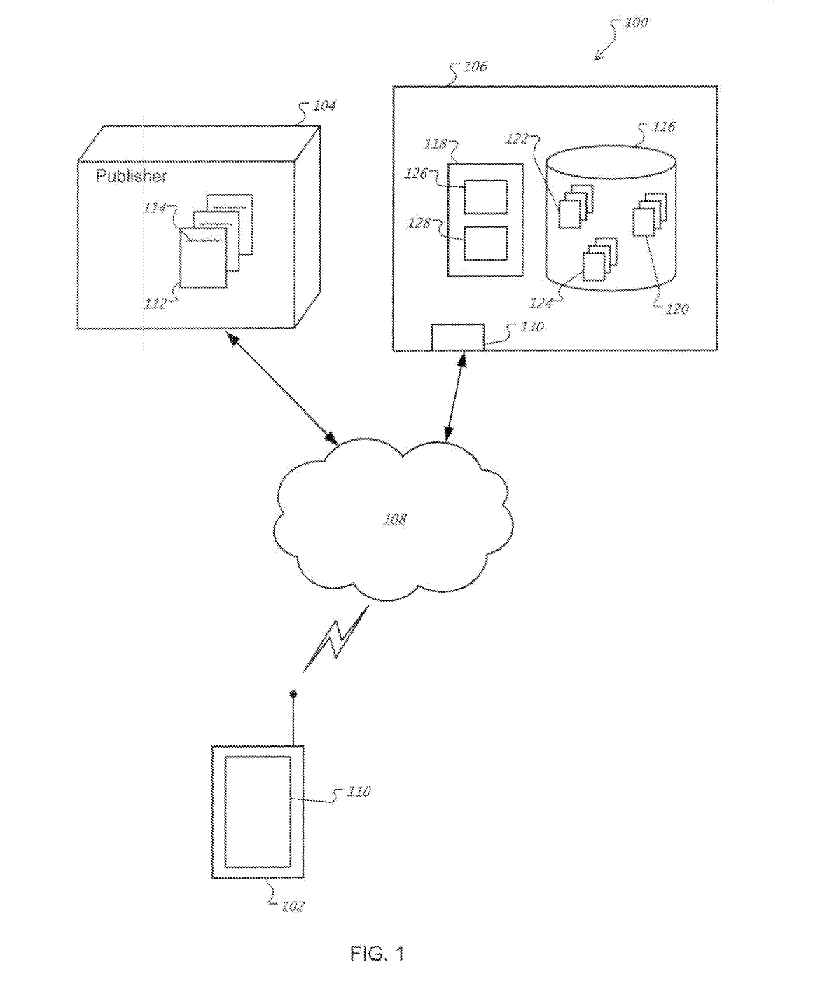

FIG. 1 illustrates an exemplary tracking system 100 for tracking actions associated with advertisements embedded in content (e.g., Web pages). For example, system 100 may track click-throughs associated with advertisements (“ads”) embedded in static Web pages. In contrast to static Web pages, dynamic Web pages include executable code for providing interactivity with the user such as dynamically updating a Web page. For example, dynamic Web pages may include inline Frame (iFrame) tags, javascript, or any other code that provides dynamic elements to an associated Web page. In this case, iFrame tags and/or javascript may be embedded in a Web page to dynamically provide advertisements and/or an ability to track these advertisements. For example, iFrame tags may embed a separate Web page in the associated Web page. System 100 may include network elements that can not process or otherwise execute embedded code and, as a result, may not be able to process dynamic Web pages independent of the advertiser. In this case, such devices may not be able to display dynamic ads and/or track the ads, such as actions performed in response to the dynamic ads. To overcome these obstacles, system 100 may associate an ad image embedded in a static Web page with a network address (e.g., Universal Resource Locator (URL) independent of the advertiser. IN doing so, system 100 may track responses (e.g., click-throughs) to the embedded ad image independent of the advertiser. In other words, system 100 may direct, using the associated network address, a response to a network element for identifying tracking information and then forward the response to the appropriate advertiser. As such, the tracking becomes independent of the advertiser. In some implementations, system 100 includes HyperText Mark-up Language (HTML) tags (e.g., Hypertext REFerence (href)) in the static Web page to track click-throughs associated with embedded ads independent of the advertiser.

At a high level, system 100 may include, in some implementations, a mobile device 102, a publisher 104, and an advertising server (“ad server”) 106 coupled to a network 108. In this implementation, mobile device 102 includes a Graphical User Interface (GUI) 110 for displaying static Web pages 112 provided by publisher 104. The illustrated Web pages 112 include ad slots 114 for embedding advertisements from ad server 106 into Web pages 112. Ad server 106 locally stores ad images 120 for embedding ads in static Web pages 112, tracking files 122 for tracking images 120, and selection criteria 124 for selecting an image 120 in response to a request from publisher 104. Continuing with this implementation, and server 106 also includes ad engine 126 and tracking engine 128. In this case, ad engine 126 selects images 120 using selection criteria 124, and tracking engine 128 tracks images 120 embedded in static Web pages 112 using tracking files 122.

Turning to a high level description of the operation of the illustrated tracking system 100, mobile device 102 transmits a request to publisher 104 for Web pages 112 for display through GUI 110. In response to at least the request, publisher 104 transmits a request to ad server 106 for an ad image 120 to embed in Web page 112. Using selection criteria 124, ad engine 126 selects image 120 and, in connection with transmitting image 120 to publisher 104, stores information associated with image 120 in tracking file 122 for tracking responses associated with the embedded ad image 120. Publisher 114 transmits the static Web page 112 and the received image 120 to mobile device 102 for display through GUI 110. In response to at least a user selecting image 120, mobile device 120 transmits information identifying or otherwise associated with the selection to tracking engine 128 of ad server 128. The illustrated elements may include some, all, or none of the describe features and functions without departing from the scope of the disclosure. The describe features and functions are for illustrative purposes only and system 100 may track advertisements embedded in static Web pages using any suitable elements and/or processes.

As for the description of the illustrated elements, mobile device 102 comprises an electronic device operable to receive and transmit wireless communication with system 100. As used in this disclosure, mobile device 102 is intended to encompass cellular phones, data phones, pagers, portable computers, smart phones, personal data assistants (PDAs), one or more processors within these or other devices, or nay other suitable processing devices capable of communicating information over a wireless link to access network 108. In the illustrated implementation, mobile device 102 may be able to transmit in multiple bands such as in the cellular band and WiFi band. In these cases, messages transmitted and/or received by mobile device 102 may be based on a cellular radio technology and/or a broadband technology. IN some implementations, mobile device 102 is a legacy device unable to execute or otherwise process dynamic Web pages. For example, mobile device 102 may be unable to process code embedded in Web pages such as javascript or iFrame tags. Generally, mobile device 102 may transmit voice, video, multimedia, text, web content or any other user/client-specific content. In short, device 102 generates requests, response or otherwise wirelessly communicates with network 108. In another example, mobile device 102 may include an input device, such as a keypad, touch screen, mouse, or other device that can accept information, and an output device that conveys information associated with an advertisement of ad server 106, including visual information through GUI 110. Both the input device and output device may include fixed or removable storage media such as a magnetic computer disk, CD-ROM, or other suitable media to both receive input from and provide output to users of mobile device 102 through the display, namely the client portion of GUI 110.

GUI 110 comprises a graphical user interface operable to allow the user of client 102 to interface with at least a portion of system 100 for any suitable purpose, such as viewing advertisements. Generally, GUI 110 provides the particular user with an efficient and user-friendly presentation of data provided by or communicated within system 100. GUI 110 may comprise a plurality of customizable frames or views having interactive fields, pull-down lists, and buttons operated by the user. For example, GUI 110 is operable to display certain ad images 120 in a user-friendly form based on the user context and the displayed data. GUI 110 may also present a plurality of portals or dashboards. GUI 110 can be configurable, supporting a combination of tables and graphs (bar, line, pie, status dials, etc.), and build real-time dashboards. The term graphical user interface may be used in the singular or in the plural to describe one or more graphical user interfaces and each of the displays of a particular graphical user interface. Indeed, reference to GUI 110 may indicate a reference to the front-end or a component of mobile device 102, as well as the particular interface accessible via client 102, as appropriate, without departing from the scope of this disclosure. Therefore, GUI 110 includes any graphical user interface, such as a generic web browser or touch screen, that processes information in system 100 and efficiently presents the results to the user. Ad server 106 can accept data from mobile device 102 via a the web browser (e.g., Microsoft Internet Explorer or Netscape Navigator) and return the appropriate, e.g., HTML or XML, responses to the browser using network 108.

Publisher 104 comprises an electronic computing device operable to receive, transmit, process and store data associated with system 100. In the illustrated implementation, publisher 104 provides web pages 112 to clients 102 for display through GUI 110. Web pages 112 comprise displays through which an advertisement can be presented to users of clients 102. In general, Web pages 112 include any machine readable and machine storable work product that may generate or be used to generate a display through GUI 110. Web pages 112 may be a file, a combination of files, one or more files with embedded links to other files, etc. Web pages 112 may include text, audio, image, video, animation, and other attributes. In short, Web pages 112 comprise any source code or object code for generating a display and providing instructions for retrieving an advertisement to embed in the display and referred to as an ad slot 114. For example, ad slot 114 may identify a banner advertisement for presenting information associated with a product and/or service. In some cases, ad slot 114 comprises an HTML tag identifying ad server 106 as the source of an image for embedding in, for example, a static Web page 112. In some implementations, the HTML tag is an image (img) tag including a network address to ad server 106.

Ad server 106 comprises an electronic computing device operable to receive, transmit, process and store data associated with system 100. System 100 can be implemented using computers other than servers, as well as a server pool. Indeed, ad serve 106 may be any computer, electronic or processing device such as, for example, a blade server, general-purpose personal computer (PC), Macintosh, workstation, Unix-based computer, or any other suitable device. In other words, system 100 may include computers other than general purpose computers as well as computers without conventional operating systems. Ad server 106 may be adapted to execute any operating system including Linux, UNIX, Windows Server, or any other suitable operating system. In certain implementations, ad server 106 may also include or be communicably coupled with a web server and/or a mail server.

Ad server 106 includes memory 116 and a processor 118. Memory 116 may be a local memory and include any memory or database module and may take the form of volatile or non-volatile memory including, without limitation, magnetic media, optical media, random access memory (RAM), read-only memory (ROM), removable media, or any other suitable local or remote memory component. In the illustrated implementation, memory 116 includes ad images 120, tracking files 122, and selection criteria 120. Here, ad images 120 refer to electronic advertisements capable of being presented on Web pages 112. Local memory 116 may also include any other appropriate data such as VPN applications or services, firewall policies, a security or access log, print or other reporting files, HTML files or templates, data classes or object interfaces, child software applications or sub-systems, and others.

Ad images 120 include any parameters, pointers, variables, algorithms, instructions, rules, files, links, or other data for easily providing secondary content for display through GUI 110. It will be understood that while user context may be described in terms of “combinations,” such various user context data may be stored or processed using at least one data structure, object, record or file. Such ad images 120 may include (among other things) primary content, secondary content, and/or sponsored content. For example, each ad image 120 may be a text element, a graphics element, a multimedia element, or any other graphical or display element. In a more specific example, ad image 120 may include a static image in any suitable format such as TIFF, and GIFF. In certain implementations, ad images 120 (or pointers thereto) may be stored in one or more table sin a relational database described in terms of SQL statements or scripts. In certain implementations, ad images 120 may be formatted, stored, or defined as various data structures in text files, eXtensible Markup Language (XML) documents, Virtual Storage Access Method (VSAM) files, flat files, Btrieve files, comma-separated-value (CSV) files, internal variables, or one or more libraries. For example, a particular ad image 120 may merely be a pointer to a third party ad stored remotely. IN another example, a particular ad image 120 may be an internally stored advertisement for products and/or services provided by an independent advertiser. In short, ad images 120 may comprise one table or file or a plurality of tables or files stored on one computer or across a plurality of computers in any appropriate format. Indeed, some or all of ad images 120 may be local or remote without departing from the scope of this disclosure and store any type of appropriate data.

Tracking files 122 include one or more entries or data structures that identify information associated ad image 120 display through GUI 110 in system 100. For example, tracking files 122 may include or identify actions associated with ad image 120 such as click-throughs. Tracking file 122 may be associated with a specific ad image 120, multiple ad images 120, a single advertiser, multiple advertisers, a single publisher 104 or multiple publishers 104 or multiple tracking files 122 may be associated with a single publisher 104, a single advertiser, or a single publisher 104. In short, tracking files 122 may include or identify one or more of the following: a network address associated with mobile device 102, a time, a date, an advertiser, ad characteristic (e.g., type, size, font, colors), publisher identifier, or any other suitable information for tracking actions associated with an ad image 120.

Selection criteria 124 may include any parameters, variables, algorithms, instructions, rules, objects or other directives for selecting ad images 116 for display in system 100. For example, selection criteria 124 may identify a current usage guidelines for ad images 116. These guidelines may merely identify a simple rotation between images 116 and/or a more complex system for selecting ad images 116. For example, selection criteria 124 may include mathematical and/or logical expressions for selecting ad images 120 based on any appropriate parameter. Alternatively or in addition to a set guideline, selection criteria 122 may include different criteria based, at least in part, on other aspects such as periods of time, user information, web page content, and/or others. For example, selection criteria 122 may include criteria for selecting ad images 120 during specified holidays (e.g., Easter season, Christmas) and/or criteria for different aspects of a user (e.g., sex, age, race, religion). In short, selection criteria 124 may include any appropriate information for selecting ad images 116.

Processor 118 executes instructions and manipulates data to perform operations of ad server 106. Although FIG. 1 illustrates a single processor 118 in server 106, multiple processors 118 may be used according to particular needs, and reference to processor 118 is meant to include multiple processors 118 where applicable. In the illustrated implementation, processor 118 executes ad engine 126 and tracking engine 128 at any appropriate time such as, for example, in response to a request or input from a user of server 106 or any appropriate compute system coupled with network 108. Ad engine 126 is any software, for example, operable to provide ad image 116 to publisher 104. In some implementations, ad engine 126 selects selection criteria 124 in response to a request for an advertisement from publisher 104. Ad engine 126 may identify usage guidelines in selection criteria 124 and based, at least in part, on the usage guidelines identify an ad image 120. After identifying ad image 120, ad engine 126 may transmit the advertisement to publisher 104 using network 108. While illustrated as a module of ad server 106, ad engine 126 may be integrated into another network device that manages ad request from network 108.

Tracking engine 128 may track viewer actions to ad images 120 based on any suitable process. In general, tracking engine 128 may store information associated with an ad image 120 transmitted to publisher 102 and responses to the ad image 120 displayed through GUI 110. In connection with transmitting an ad image 120 to publisher 104, tracking engine 128 may identify a tracking file 122 associated with ad image 120 and store information in the tracking file 122. For example, tracking engine 128 may store one or more of the following in tracking file 122; a network address associated with mobile device 102, a time, a date, an advertiser, ad characteristics (e.g., type, size, font, colors), a network address associated with an advertiser, publisher identifier, a tracking identifier or any other suitable information for tracking actions associated with an embedded ad image 120. As for the tracking identifier, tracking engine 128 may store an identifier associated with ad image 120 in tracking file 122 and, in response to a user selecting the embedded image 120, store information identifying or otherwise associated with the selection of ad image 120 in accordance with the identifier. The tracking identifier may be unique to the specific request. For example, the tracking identifier may based on the network address of ad server 106, a date, and/or a time. In using a unique identifier, tracking engine 128 may track specific instances of image 120. In connection with tracking ad image 120, tracking engine 128 may identify a network address associated with the advertiser and transmit the response to the advertiser. In some implementations, the response from device 102 is a request for additional information associated with ad image 120. Tracking engine 128 may retrieve the network address associated with the advertiser from tracking file 122. In some implementations, the response from device 102 may include the network address associated with the advertiser. For example, the unique identifier may be based on the associated network address. Regardless, tracking engine 128 transmits the request to the appropriate advertiser. As a result of initially receiving the response, tracking engine 128 may track ad image 120 independent of the associated advertiser.

Regardless of the particular implementation, “software” may include software, firmware, wired or programmed hardware, or any combination thereof as appropriate. Indeed, ad engine 126 and tracking engine 128 may be written or described in any appropriate computer language including C, C++, Java, J#, Visual Basic, assembler, Perl, any suitable version of 4GL, as well as others. It will be understood that while ad engine 126 and tracking engine 128 are illustrated in FIG. 1 as including individual modules, each of ad engine 126 and tracking engine 128 may including numerous other sub-modules or may instead be a single multi-tasked module that implements the various features and functionality through various objects, methods, or other processes. Further, while illustrated as internal to server 106, one or more processes associated with ad engine 126 and/or tracking engine 128 may be stored, referenced, or executed remotely. Moreover, ad engine 126 and/or tracking engine 128 may be a child or sub-module of another software module or enterprise application (not illustrated) without departing from the scope of this disclosure.

Ad server 106 may also include interface 130 for communicating with other computer systems, such as clients 102, over network 108 in a client-server or other distributed environment. In certain implementations, ad server 106 receives data from internal or external senders through interface 130 for storage in local memory 120 and/or processing by processor 125. Generally, interface 130 comprises logic encoded in software and/or hardware in a suitable combination and operable to communicate with network 108. More specifically, interface 130 may comprise software supporting one or more communications protocols associated with communications network 108 or hardware operable to communicate physical signals.

Network 108 facilitate wireless or wireline communication between server 106 and any other local or remote computer, such as clients 102. Network 108 may be all or a portion of an enterprise or secured network. While illustrated as single network, network 108 may be a continuous network logically divided into various sub-nets or virtual networks without departing from the scope of this disclosure, so long as at least portion of network 108 may facilitate communications of ad images 120 and attribute profiles 120 between server 106 and at least one client 102. In some implementations, network 108 encompasses any internal or external network, networks, sub-network, or combination thereof operable to facilitate communications between various computing components in system 100. Network 108 may communicate, for example, Internet Protocol (IP) packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations.

In one aspect of operation, mobile device 102 transmits a request for a static Web page 112 to publisher 104. In response to at least the request, publisher 104 identifies the requested static Web page 112. In accordance with ad slot 114, publisher 104 transmits a request to ad server 106 for an ad image 120 to embed in the request Web page 112. Ad engine 126 identifies selection criteria 124 in response to at least the request and using the identified selection criteria 124, identifies ad image 120. Ad server 106 transmits the identified ad image 120 to publisher for embedding in the static Web page 112. In connection with providing ad image 120, tracking engine 128 may generate an identifier associated with the identified ad image 120 and store the identifier in tracking file 122 for tracking actions associated with ad image 120. Device 102 may receive a selection of ad image 120 through GUI 110 and, in response to at least the selection, transmit a request to ad server 106 for additional information associated with the selected ad image 120. Tracking engine 120 receives the request for additional information and identifies the associated ad image 120. Tracking engine 120 may identify an identifier associated with the specific instance of ad image 120. Tracking engine 120 may identify one or more tracking files associated with ad image 120 and may store information associated with the request in accordance with the identifier. In connection with storing tracking information, tracking engine 120 may transmit the request to the appropriate advertiser.

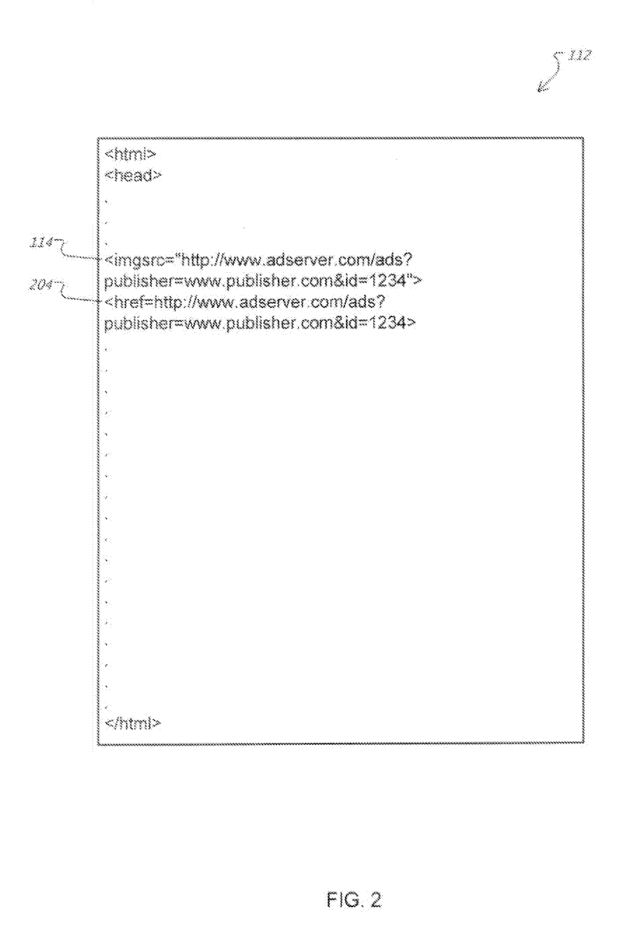

FIG. 2 is an example Web page 112 including an ad slot 114 for embedding an ad image 120. It will be understood that the illustrated page is for example purposes only. Accordingly, GUI 110 may include or present advertisements, in any format or descriptive language and each page may present any appropriate advertisements in any layout without departing from the scope of the disclosure.

Web page 112 illustrates a static Web page written in HTML code. In the illustrated implementation, Web page 112 includes ad slot 114 and Hypertext REFerence (href) 204. Ad slot 114 includes an image source (img src) tag for embedding a static image in static Web page 112 such as ad image 120. In the illustrated implementations, ad slot 114 identifies ad server 106 as the source of the embedded advertisement. In response to processing ad slot 114, publisher 104 transmits a request for an advertisement and, in response, receives ad image 120. Href 204 includes information for directing a selection from a user of device 102 to ad server 106. In this case, href 204 includes the network address of ad server 106. In doing so, mobile device 102 may transmit a request to ad server 106 for additional information in response to at least the user selecting ad image 120 through GUI 110. As mentioned above, system 100 may transmits selections directly to ad server 106 to enable tracking ad images 120 independent of associated advertisers.

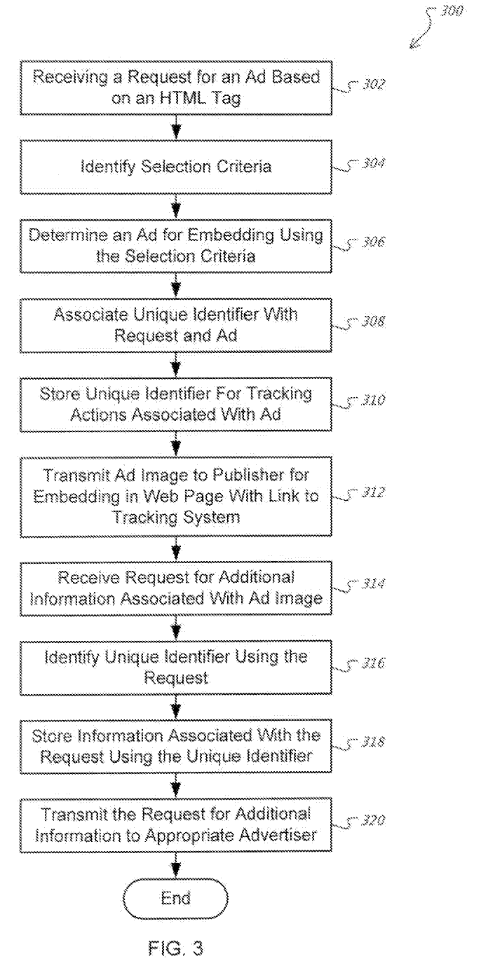

FIG. 3 is a flowchart illustrating an example method 300 for tracking advertisements embedded in static Web pages in accordance with some implementations of the present disclosure. Generally, method 300 describes an example technique where advertisements are selected for embedding in static Web pages, responses to the advertisements are received, and these response are automatically tracked, for example, independent of the Web-page publisher and the advertiser. System 100 contemplates using any appropriate combination and arrangement of logical elements implementing some or all of the described functionality.

At a high level, method 300 includes two process: (1) providing an ad for embedding in a static Web page provide by a publisher in steps 302 to 312; and (2) tracking click-throughs of the ad (e.g., independent of the advertiser) in steps 314 to 320. In regards to providing the ad, method 300 begins at step 302 where a request for ad is received for embedding in a static Web page (e.g., using an HTML tag). For example, ad engine 126 may receive a request from publisher 104 for an image 120 to embed an advertisement in a Web page 112 using ad slot 114. At step 304, criteria for selecting an ad is identified. In the example, ad engine 126 may identify selection criteria 124 in response to at least the requires from publisher 104. Next, an ad for embedding in the static Web page is determined using the selection criteria. Again returning to the example, ad engine 126 identifies image 120 based, at least in part, on the selection criteria 124. In this example, ad engine 126 may identify an ad for a sports car to embed in a Web page containing sports information. In connection with selecting the ad, a unique identifier is associated with the selected ad. In the example, ad engine 126 may associated a unique identifier based on a URL and a time stamp with the selected image 120. The unique identifier is locally stored for tracking actions associated with the selected at step 310. As for the example, ad engine 126 stores the unique identifier in tracking files 122 for tracking actions (e.g., click-throughs) associated with the embedded image 120. The selected ad image is transmitted to the publisher for embedding in the static Web page at step 312. In the example, ad engine 126 transmits the selected image 120 for embedding in the static Web page 112.

Turning to the tracking process, a request to receive additional information associated with the advertiser is received at step 314. In the example, tracking engine 128 receives a request for additional information from mobile device 102 in response to at least the user selecting the advertisement. For example, the user may select the embedded image 120 displayed through GUI 110. At step 316, the unique identifier is identified based, at least in part, using the request. As for the example, tracking engine 128 identifies the unique identifier based, at least in part, on the received request. Next, information associated with the request is locally stored using the unique identifier at step 318. In the example, tracking engine 128 identifies a tracking file 122 associated with the unique identifier and stores information associated with the request in the identified tracking file 122 in accordance with the unique identifier. The request for additional information is transmitted to the appropriate advertiser at step 320. In connection with populating tracking files 122 with the tracking information, tracking engine 128 transmits the request to the appropriate advertiser.

Although this disclosure has been described in terms of certain implementations and generally associated methods, alternations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A method for tracking advertisements, comprising:
in response to at least a request for an advertisement to embed in a static Web page, transmitting a static image for displaying an advertisement in the static Web page, the advertisement associated with an advertiser; and
tracking actions associated with the embedded ad image independent of the advertiser.

2. The method of claim 1, further comprising:
receiving, from a Web-page publisher, a request for an advertisement to embed in a static Web page; and
transmitting, to the Web-page publisher, an image for displaying an advertisement in response to at least the request, the advertisement associated with an advertiser.

3. The method of claim 1, wherein tracking actions comprises:
receiving a request for additional information associated with the advertisement;
storing information associated with the advertisement based, at least in part, on the request; and
transmitting, to the advertiser, the request for additional information associated with the advertisement.

4. The method of claim 3, that static image is configured to be associated with a Hypertext REFerence (href) tag comprising a network address different from the advertiser.

5. The method of claim 3, further comprising:
populating a file with an identifier associated with the static image; and
populating the file with information associated with the request for additional information in accordance with the identifier.

6. The method of claim 1, further comprising:
identifying criteria for selecting an advertisement based, at least in part, on the request; and
identifying the static image in accordance with the selection criteria.

7. The method of claim 1, further comprising:
associating a unique identifier with the specific instance of the static image; and
populating a file with the unique identifier and information associated with the request.

8. The method of claim 7, the request received from a Web-page publisher, the unique identifier based, at least in part, on a Uniform Resource Locator (URL) of the Web-page publisher and a time stamp.

9. The method of claim 1, a mobile device displays the static Web page and the static image.

10. The method of claim 1, the static image is embedded using a source image (src img) tag.

11. Software for tracking advertisements comprising computer readable instructions embodied on media and operable to:
in response to at least a request for an advertisement to embedded in a static Web page, transmit a static image for displaying an advertisement in the static Web page, the advertisement associated with an advertiser; and
track actions associated with the embedded ad image independent of the advertiser.

12. The software of claim 11 further operable:
receive, from a Web-page publisher, a request for an advertisement to embed in a static Web page; and
transmit, to the Web-page publisher, an image for displaying an advertisement in response to at least the request, the advertisement associated with an advertiser.

13. The software of claim 11, wherein the software operable to track actions comprises software operable to:
receive a request for additional information associated with the advertisement;
storing information associated with the advertisement based, at least in part, on the request; and
transmitting, to the advertiser, the request for additional information associated with the advertisement.

14. The software of claim 13, a href tag associated with the static image comprising a network address different the advertiser.

15. The software of claim 13 further operable to:
populate a file with an identifier associated with the static image; and
populate the file with information associated with the request for additional information in accordance with the identifier.

16. The software of claim 11 further operable to:
identify criteria for selecting an advertisement based, at least in part, on the request; and
identify the static image in accordance with the selection criteria.

17. The software of claim 11 further operable to:
associate a unique identifier with the specific instance of the static image; and
populate a file with the unique identifier and information associated with the request.

18. The software of claim 17, the request received from a Web-page publisher, the unique identifier based, at least in part, on a Uniform Resource Locator (URL) of the Web-page publisher and a time stamp.

19. The software of claim 11, a mobile device displays the static Web page and the static image.

20. The software of claim 11, the static image is embedded using a src img tag, the static image is associated.

21. A server for tracking advertisements comprising one or more processors operable to:
in response to at least a request for an advertisement to embedded in a static Web page, transmit a static image for displaying an advertisement in the static Web page, the advertisement associated with an advertiser; and
track actions associated with the embedded ad image independent of the advertiser.

22. The server of claim 21 further operable:
receive, from a Web-page publisher, a request for an advertisement to embed in a static Web page; and
transmit, to the Web-page publisher, an image for displaying an advertisement in response to at least the request, the advertisement associated with an advertiser.

23. The server of claim 21, wherein the server operable to track actions comprises the server operable to:
receive a request for additional information associated with the advertisement;
storing information associated with the advertisement based, at least in part, on the request; and
transmitting, to the advertiser, the request for additional information associated with the advertisement.

24. The server of claim 23 further operable to:
populate a file with an identifier associated with the static image; and
populate the file with information associated with the request for additional information in accordance with the identifier.

25. The server of claim 11 further operable to:
identify criteria for selecting an advertisement based, at least in part, on the request; and
identify the static image in accordance with the selection criteria.

26. The server of claim 1, further operable to:
associated a unique identifier with the specific instance of the static image; and
populate a file with the unique identifier and information associated with the request.

27. A system for tracking advertisements, comprising:
a means for transmitting a static image for displaying an advertisement in the static Web page in response to at least a request for an advertisement to embed in a static Web page, the advertisement associated with an advertiser; and
a means for tracking actions associated with the embedded ad image independent of the advertiser.
